(19) United States
(12) Patent Application Publication
(10) Pub. No.: US 2009/0112806 A1
(43) Pub. Date: Apr. 30, 2009

(54) QUERY VIEW INFERRED FROM DATASOURCE AND QUERY

(75) Inventors: Lili Cheng, Bellevue, WA (US); Stacey Harris, Redmond, WA (US); Andrzej Turski, Redmond, WA (US); Matthew Maclaurin, Woodinville, WA (US); Shane F Williams, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/930,754

(22) Filed: Oct. 31, 2007

(51) Int. Cl. G06F 17/30

(52) U.S. Cl. 707/3; 707/E17.14

(57) ABSTRACT

The disclosed technique analyzes the source of the query and the query itself, to automatically determine the results view presented to the user. This view can be inferred or authored. Before the query is displayed, the query and the source can be analyzed, the results of which are then passed as view control information to the view control component. In addition, analysis can be performed on the type of items in the result set, number of items in the result set, and/or previously selected views of the user and/or from a community of users. For example, if the results are all images, the view is for images, and if the result set is very large, the results can be shown in a grouped view. The user can be provided the option to override the default view.

### BACKGROUND

When conducting conventional searches (e.g., online or offline), the results are returned as a list in a particular view and format. For example, in some online search engines, the results are returned and displayed as a text list of items ranked by importance. While there are ways for the users to explicitly alter the search results view as to see results as a grid of thumbnail images of the websites, there is no way for the view to be automatically determined based on the results or query. In other words, conventionally, if the user wants to view pictures of “John Doe”, the user needs to select a link denoted “photos” or the like, in response to which a new query is issued which shows the user the results of “John Doe pictures.”

This may be an adequate solution when searching the online, because users are mostly searching across a set of web pages. However, as the user searches across different types of sources and data (e.g., local files, photos that have been tagged on photo-sharing websites, video collections, etc.) different views are more appropriate. The way that query results will be displayed is typically hard-coded and authored by the developers without user options. Thus, it becomes more cumbersome to pick different views as the user's search application and controls aggregate and search across all these different sources.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed technique analyzes the source of the query and the query itself, to automatically determine the results view presented to the user. This view can be inferred or authored. Before the query is displayed, the query and the source can be analyzed, the results of which are then passed as view control information to the view control component. In addition, analysis can be performed on the type of items in the result set, number of items in the result set, and/or previously selected views of the user and/or from a community of users. For example, if the results are all images, the view is for images, and if the result set is very large, the results can be shown in a grouped view.

The user can be provided the option to override the default view. If overridden, this can be another input for determining subsequent view state. For example, if a local search is performed for “dog pictures” and the view is switched from a default thumbnail view to a detail view, this will be remembered. Thereafter, in a subsequent action in the search session the user searches for “cat pictures”, the default thumbnail view will continue to be overridden to provide detail view.

In another example, if the user queries for “system pictures” and the system automatically analyzes the query to determine to present thumbnail view, the user can inspect the results and if no thumbnail pictures were found, the user could override the view to present a details view.

In addition to the query the user enters, the results view presented can be based on the source of the query. For example, if the set of items is predominately images/videos, the results can be shown in thumbnail view. For web page results, the view can be shown as extended details. For documents, the results can be shown as details view. Our search control can pass the view control information so the view control can determine the best view. In addition, developer and/or end users can override the default to design the view best for their application. If end users or developers add search sources, default views can be used or the view can be explicitly set. Custom views can also be configured for a particular purpose. If the system has insufficient information to decide on a view, the default view can be selected and presented for a generic set of items.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and equivalents. Other advantages and novel features will become apparent from the following detailed description when considered in conjunction with the drawings.

### BRIEF DESCRIPTION OF THE DRAWINGS

FIG. 1 illustrates a computer-implemented system for presenting a view based on a query process.

FIG. 2 illustrates functionality of the analysis component for outputting view control information.

FIG. 3 illustrates that additional information can be processed to determine the view in which the query results will be presented.

FIG. 4 illustrates an exemplary user interface (UI) of an application that infers the results view based on the query.

FIG. 5 illustrates an exemplary UI via which a user can use a default view or explicitly set a new view.

FIG. 6 illustrates a method of presenting search results.

FIG. 7 illustrates a method of inferring a results view based on query analysis.

FIG. 8 illustrates a method of inferring a results view based on results analysis.

FIG. 9 illustrates a block diagram of a computing system operable to infer results views in accordance with the disclosed architecture.

### DETAILED DESCRIPTION

With the folder-based organization, specific views can be assigned to folders, for example, a thumbnail view to a folder with pictures, or calendar view for an email folder with meeting requests. However, classifying all items into appropriate folders is time consuming, inflexible, and not always possible (e.g., if items are stored across multiple devices or on the Internet). Contemporary systems augment stiff folder organization with ad-hoc queries based on fast search algorithms. However, the switch from folders to queries creates a functionality loss when it comes to selecting the most appropriate view.

The disclosed architecture provides a solution to presenting the most appropriate view by employing a richer user experience that automatically determines the view for the user for a query process. The view can be inferred based on different aspects of the query process, including but not limited to, the query and the datasource against which the query is being executed, the device from which the query is being performed, location of the user when making the query, the results returned, and so on. The results can then be presented in a sorted order, ranked, grouped stacked, etc., based on the aspects being analyzed during the query process. This facilitates a much more automated and pleasant user experience.

Aspects of the query view that can be adjusted automatically include, but are not limited to: a grouping and/or individual items view; the representation of groups where the groups can be presented as group icons, stacks, containers with some or all items visible, etc.; the representation of individual items where the individual items can be presented as icons, lists of selected properties, partial or complete content, preview images, etc.; a blend of the previously mentioned item views and representations, where some items are shown in groups and some items are shown individually, and each group/item may have a different view; and, a visible order of the groups and items, where the groups and items are sorted according to certain properties (e.g., name, date, etc.), and/or placed in some arbitrary user-defined way.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

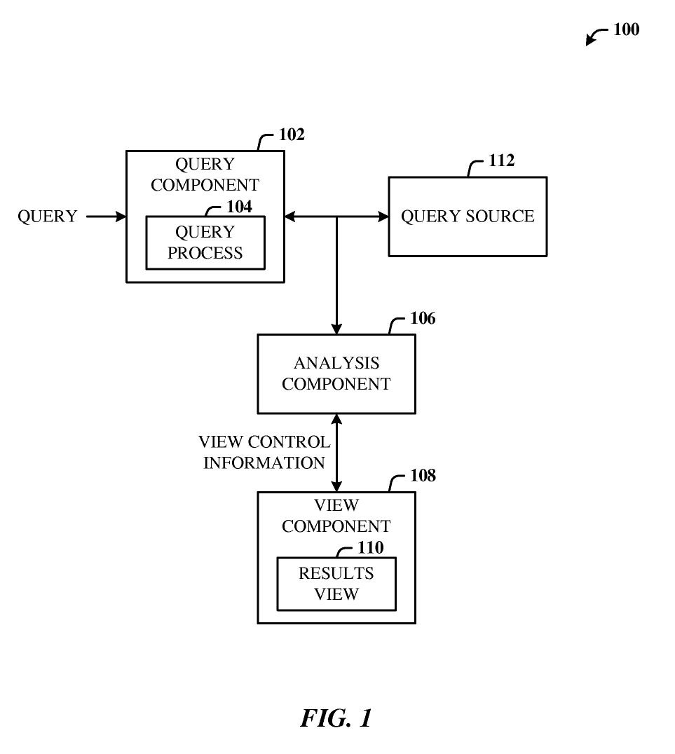

In support thereof, FIG. 1 illustrates a computer-implemented system 100 for presenting a view based on a query process. The system 100 can include a query component 102 for receiving a query for execution as part of a query process 104 to return query results. An analysis component 106 analyzes the query process 104 for query information. The query information includes the attributes or properties of the query itself (e.g., terms, natural language, media type, etc.), other information related the time of day, day of week, user making the query, user preferences, application via which the query is being made, user settings, connection bandwidth, and so on.

A view component 108 receives the output from the analysis component 106 and presents a view 110 (list versus images) of based on the query information. The analysis component 106 can also process a cost function that computes a cost associated with different aspects of the query process. For example, based on the device information (e.g., a cell phone), the output of the cost function can indicate that is it more preferable to present the results view 110 in a way that is more conducive to the smaller display of the phone (e.g., text), rather than the larger display of a portable or desktop computer system (e.g., images).

The system 100 also includes a query source 112 against which the query is executed. The source 112 represents a single entity (e.g., local storage subsystem) of multiple types of files and data or multiple separate sources (e.g., web server, website, local storage subsystem, etc.) having the same or different types of data stored. The analysis component 106 can also analyze the data stored on the source 112 as a factor to consider when determining the view 110 for the results. For example, if the source stores predominantly photos, the results can then be presented as thumbnail views for the results. If the source searched is a website for which web pages will be returned as the results, the analysis component 106 will infer that the results view 110 will be as extended details. If the search is to the source 112 which is a local storage subsystem of documents, the results view 110 can be in details. Thus, the analysis component 106 passes the view control information to the view component 108 can determine or infer the best view. The developer or end users can also override the default to configure the view desired for a user application.

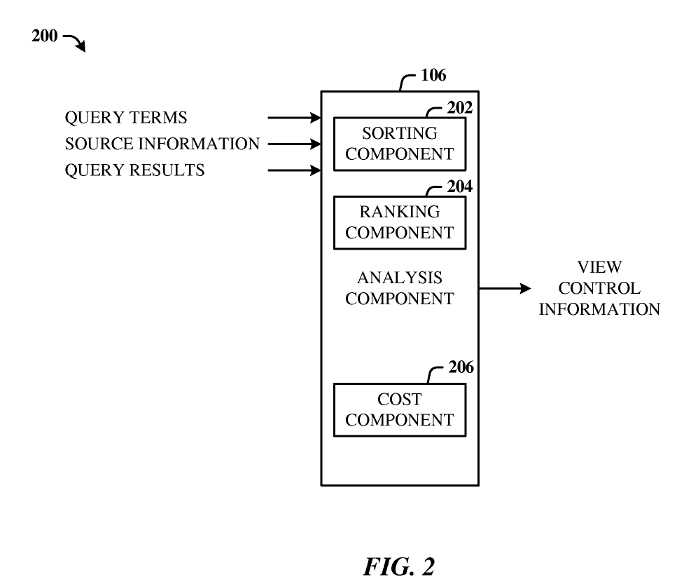

FIG. 2 illustrates functionality of the analysis component 106 for outputting view control information. The analysis component 106 analyzes the query process for query information 200 related at least to the query terms used in the query before query execution and/or after execution, source information about the source and the data stored on the source, and the query results. The analysis component 106 can include a sorting component 202 for sorting the results according to sorting criteria, for example, by author, date, data size, data type, etc.

If the query contains words such as “picture”, or “documents”, this is an indication that appropriate views for that type could be used (e.g., thumbnails or details). If the query contains some specific ambiguous terms, such as “recent” or “large”, this may be an indication that view results can be sorted by the corresponding property of date or file size, for example.

With respect to the utilization of source information, if the datasource is known to contain predominantly some type of items (e.g., images), the appropriate view (e.g., thumbnails) can be automatically determined and invoked. Additionally, some datasources may have a specific view associated with those data sources, since it is known that the items stored there have certain additional properties. For example, the default view for items in an email message store can include properties such as “sender”, “date send”, “read/unread” status, etc. Similarly, album-based grouping and cover art images may be used in a music store.

With respect to using query results, the query result set can be analyzed to determine the best view based on the actual items returned. For example, if the majority of items are email attachments, one preferred view can be a details view with additional email-related columns. If the set of items is large, it may be desirable to use a group (or stack) view rather than a long list. If the items are of multiple types, the items can be automatically grouped by item type and then assign item-appropriate views to each group (stack). Alternatively, heuristic analysis can be applied to determine the best grouping property.

The results view can also be inferred based on the sort order. In other words, if the sort indicates that a majority of the results are images, it can be inferred that the results view is for a thumbnail view. A ranking component 204 ranks the final set of results based on ranking criteria, for example, most number of hits, most recent, etc.

The results view can also be inferred based on the ranking results. Optionally, a cost component 206 can be employed that operates a cost function over the query information (e.g., query term(s), source information, query results, etc.) to determine a cost processing the view control information for a given set of query information. For example, if a first pass indicates that presenting the results according to a first one view is too high in terms of view processing for example, a second pass can be performed on a different view to determine the cost. If the cost is acceptable (e.g., within view configuration parameters) on the second pass, then the view results can be presented according to the second pass view.

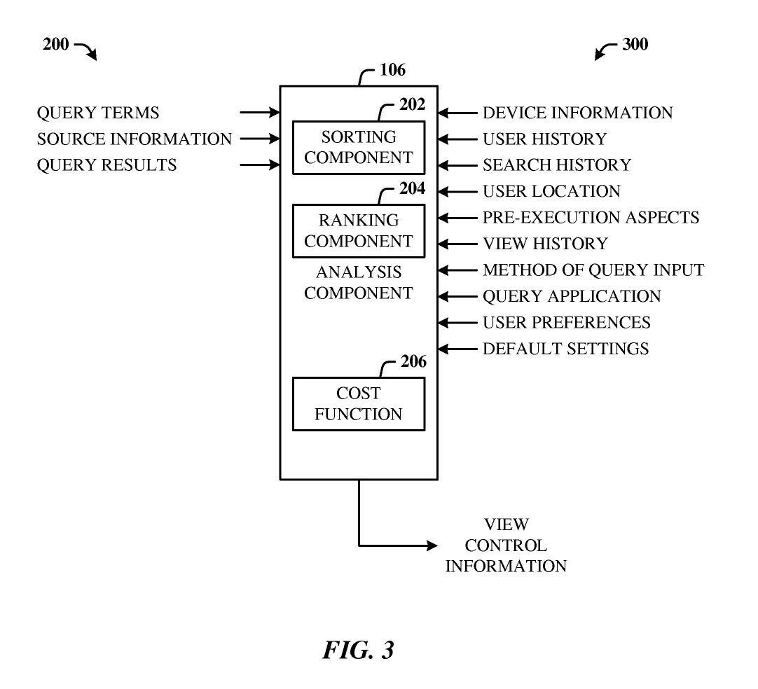

FIG. 3 illustrates that additional information 300 can be processed to determine the view in which the query results will be presented. In addition to the query terms, source, and/or results, the system can analyze additional information 300 that includes device information, user history, search history, user location, pre-execution aspects, view history, the method of query input, the application from which the query is being executed, user preferences, and default settings, for example.

The device information such as processor type, memory capacity, operating system, etc., can be analyzed to infer the view. This is because if the device is limited in hardware and/or software capability the view can be adjusted to accommodate the limited capabilities. In a specific example of a cell phone, the display is small and the processing capability is limited. Thus, a query for pictures stored on the phone can result in the view being a details view rather than a thumbnail view. Alternatively, if the device is a desktop computer running dual CPUs and a large amount of memory, the view will not be limited such that the pictures searched for can be presented as thumbnails. This same scenario applies to other result types, such as audio files and video files, for example, which can impose higher hardware and/or software capabilities on the system than simply text files.

User history can also be used to infer the view. For example, if the user has a history of viewing the results as thumbnails, this can be tracked and used to infer the view for the next query operation. This can also include the user history of other users. If the other users typically view the results in a details view, it can be inferred that this user will choose the same view. This is similar to search history where previous searches for a particular type of data can be used to infer the view for a current search of the same type of data.

User location can be considered. In other words, if the user making the query is currently away from the office, it can be inferred that the view is to be a less hardware intense rendering of the query results (e.g., a details view versus an image view). Pre-execution aspects include background processing of the query and/or query terms before execution of the query against the selected datasource. In other words, the system can run a pre-execution check based on the query terms before the query engine searches against the datasource.

The view history can also be considered when inferring the results view for the current query. If the query or a query of similar terms has in the past present the results according to a first view, then the system can analyze the historical information to infer the view for the similar query at this time.

The method of query input can also be an indicator of the preferred view of the results at this time. For example, if the query is input via voice recognition, it can be inferred that the user is searching for voice or audio files and that the results will be viewed as an extended details view. If the input is via an application, it can be inferred that the results will be viewed in a format similar to that which the application can process (e.g., details view for a document application, thumbnail view for a photo application, etc.),

User preferences of an application of the system in general can be analyzed to determine the results view. It can be that the user prefers all results to be presented in a details view. The default settings can be configured by the application via which the query is being processed, and can be analyzed to determine the results view. These are only a few examples of the sources of additional information that can be used to infer the results view. Other sources can be configured and considered such as time of day, day of week, type of information being searched, etc.

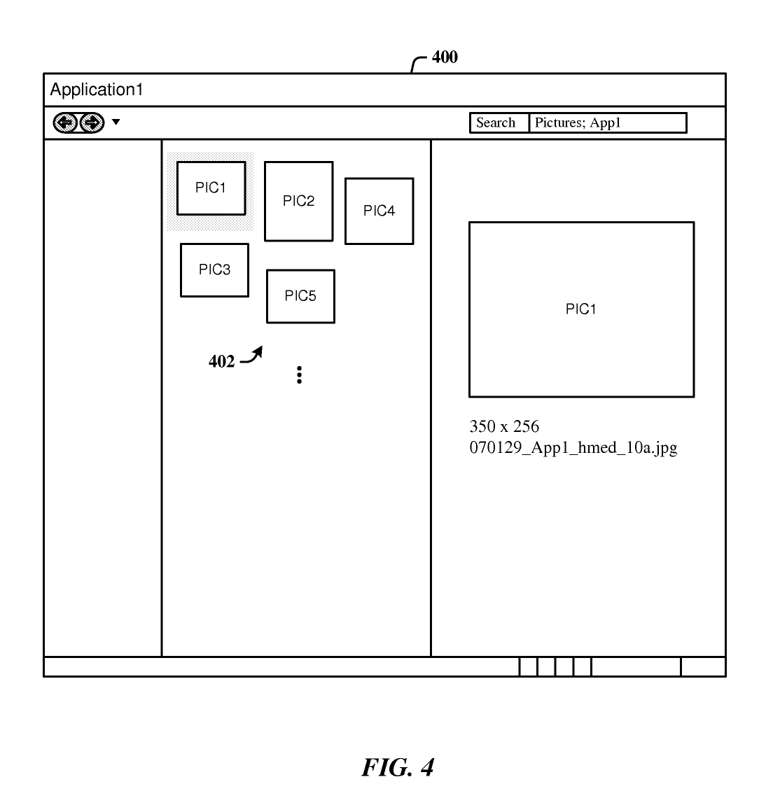

FIG. 4 illustrates an exemplary user interface (UI) 400 of an application that infers the results view based on the query. Here, the user enters a query for “pictures”. The query results are then inferred to be presented as thumbnails 402 in a thumbnail view based on the term “pictures” analyzed from the query string.

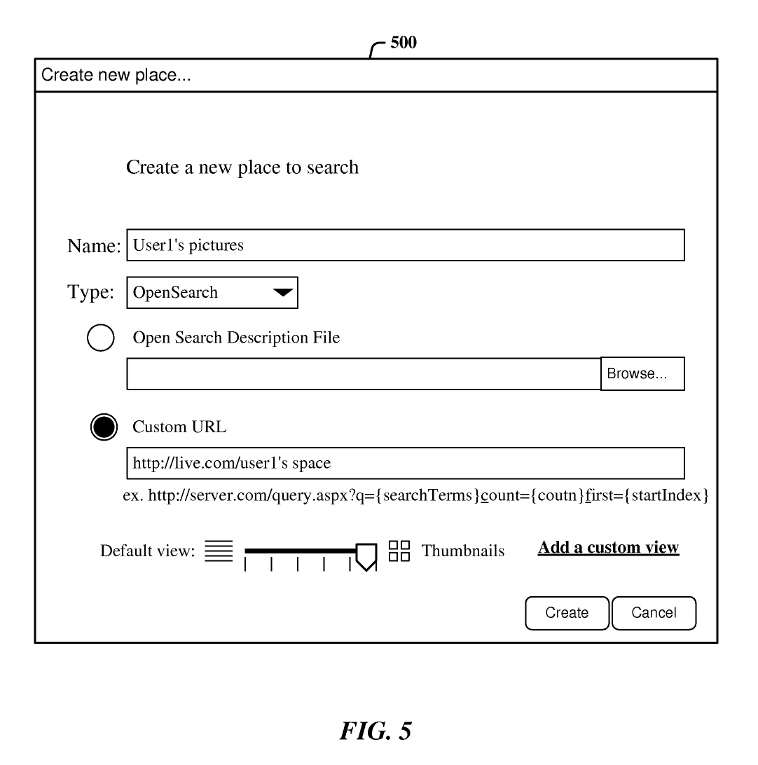

FIG. 5 illustrates an exemplary UI 500 via which a user can use a default view or explicitly set a new view. The user can specify a new search source and then customize the view specifically for that source.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

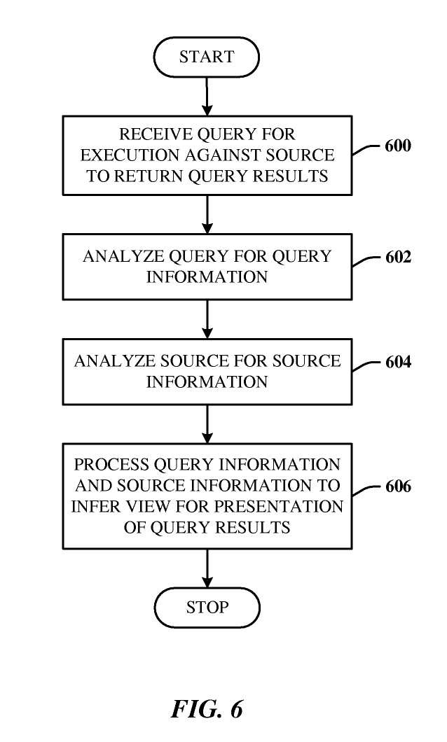

FIG. 6 illustrates a method of presenting search results. At 600, a query is received for execution against a source to return query results. At 602, the query is analyzed for query information. At 604, the source of the query is analyzed for source information. At 606, the query information and the source information are processed to infer a view for presentation of the results.

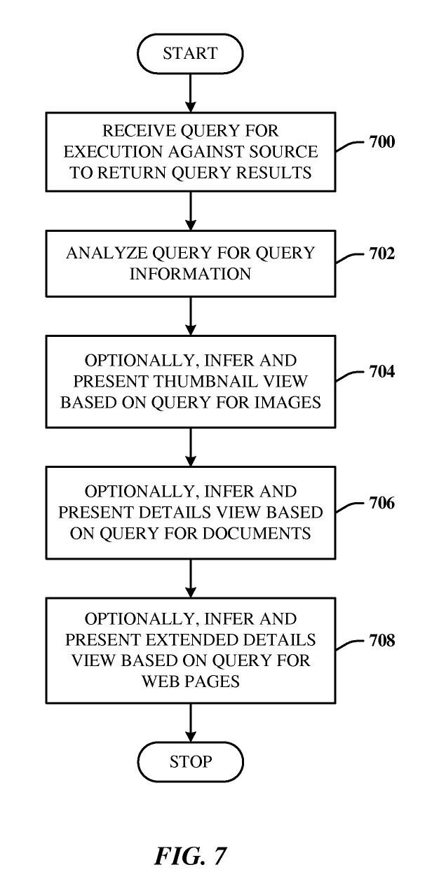

FIG. 7 illustrates a method of inferring a results view based on query analysis. At 700, a query is received for execution against a source to return query results. At 702, the query is analyzed for query information. At 704, optionally, infer and present thumbnail view based on query information of the query that is related to images. At 706, optionally, infer and present a details view based on query information of the query that is related to documents. At 708, optionally, infer and present an extended details view based on query information of the query that is related to web pages.

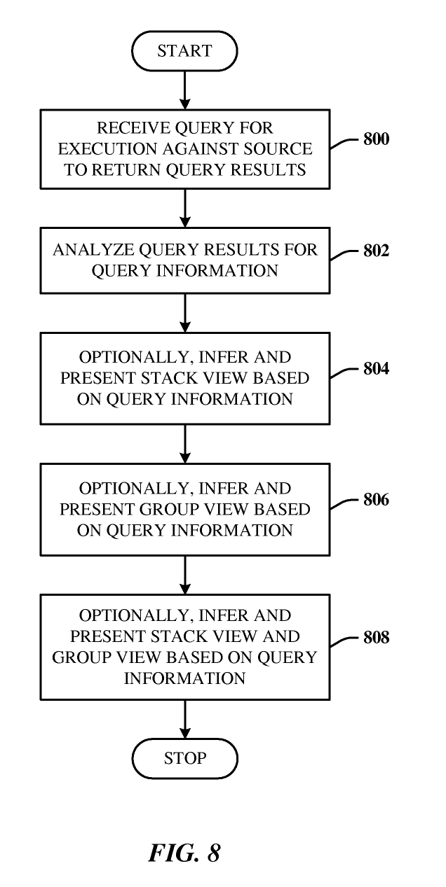

FIG. 8 illustrates a method of inferring a results view based on results analysis. At 800, a query is received for execution against a source to return query results. At 802, the query results are analyzed for query information. At 804, optionally, infer a stack view based on the query information. At 806, optionally, infer a group view based on the query information. At 808, optionally, infer a combined stack view and a group view based on the query information.

While certain ways of displaying information to users are shown and described with respect to certain figures as screenshots, those skilled in the relevant art will recognize that various other alternatives can be employed. The terms “screen,” “screenshot”, “webpage,” “document”, and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

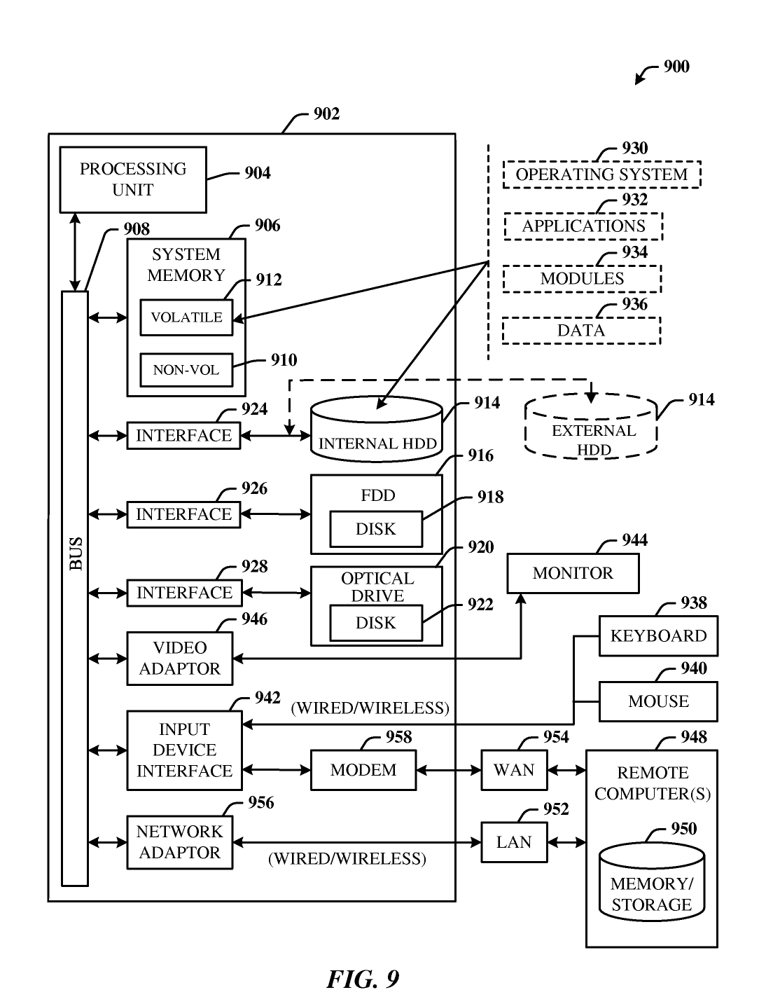

Referring now to FIG. 9, there is illustrated a block diagram of a computing system 900 operable to infer results views in accordance with the disclosed architecture. In order to provide additional context for various aspects thereof, FIG. 9 and the following discussion are intended to provide a brief, general description of a suitable computing system 900 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 9, the exemplary computing system 900 for implementing various aspects includes a computer 902 having a processing unit 904, a system memory 906 and a system bus 908. The system bus 908 provides an interface for system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 can include non-volatile memory (NON-VOL) 910 and/or volatile memory 912 (e.g., random access memory (RAM)). A basic input/output system (BIOS) can be stored in the non-volatile memory 910 (e.g., ROM, EPROM, EEPROM, etc.), which BIOS stores the basic routines that help to transfer information between elements within the computer 902, such as during start-up. The volatile memory 912 can also include a high-speed RAM such as static RAM for caching data.

The computer 902 further includes an internal hard disk drive (HDD) 914 (e.g., EIDE, SATA), which internal HDD 914 may also be configured for external use in a suitable chassis, a magnetic floppy disk drive (FDD) 916, (e.g., to read from or write to a removable diskette 918) and an optical disk drive 920, (e.g., reading a CD-ROM disk 922 or, to read from or write to other high capacity optical media such as a DVD). The HDD 914, FDD 916 and optical disk drive 920 can be connected to the system bus 908 by a HDD interface 924, an FDD interface 926 and an optical drive interface 928, respectively. The HDD interface 924 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 912, including an operating system 930, one or more application programs 932, other program modules 934, and program data 936. The one or more application programs 932, other program modules 934, and program data 936 can include the query component 102, query process 104, analysis component 106, view component 108, results view 110, query source 112, sorting component 202, ranking component 204, cost function 206, additional information 300, UI 400, and UI 500, for example.

All or portions of the operating system, applications, modules, and/or data can also be cached in the volatile memory 912. It is to be appreciated that the disclosed architecture can be implemented with various commercially available operating systems or combinations of operating systems.

A user can enter commands and information into the computer 902 through one or more wire/wireless input devices, for example, a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces such as a parallel port, IEEE 1394 serial port, a game port, a USB port, an IR interface, etc.

A monitor 944 or other type of display device is also connected to the system bus 908 via an interface, such as a video adaptor 946. In addition to the monitor 944, a computer typically includes other peripheral output devices (not shown), such as speakers, printers, etc.

The computer 902 may operate in a networked environment using logical connections via wire and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wire/wireless connectivity to a local area network (LAN) 952 and/or larger networks, for example, a wide area network (WAN) 954. Such LAN and WAN networking environments are commonplace in offices and companies, and facilitate enterprise-wide computer networks, such as intranets, all of which may connect to a global communications network, for example, the Internet.

When used in a LAN networking environment, the computer 902 is connected to the LAN 952 through a wire and/or wireless communication network interface or adaptor 956. The adaptor 956 can facilitate wire and/or wireless communications to the LAN 952, which may also include a wireless access point disposed thereon for communicating with the wireless functionality of the adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wire and/or wireless device, is connected to the system bus 908 via the input device interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi (or Wireless Fidelity) and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3 or Ethernet).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system for presenting a view, comprising:
a query component for receiving a query for execution as part of a query process to return query results;
an analysis component for analyzing the query process for query information; and
a view component for presenting a results view based on the query information.

2. The system of claim 1, wherein the analysis component analyzes a source of the query as part of the query process and infers presentation of the view based on the source.

3. The system of claim 1, wherein the analysis component analyzes the query as part of the query process and infers presentation of the view based on the query.

4. The system of claim 1, wherein the view component automatically overrides a default results view to present a new results view.

5. The system of claim 1, wherein the view presented is based on a previously-selected view.

6. The system of claim 1, wherein the view presented is authored.

7. The system of claim 1, wherein the view presented is based on item types in a result set of the query.

8. The system of claim 1, wherein the analysis component analyzes extra information in combination with the query information to determine the view.

9. The system of claim 1, wherein the analysis component sorts and ranks the results and send the ranking as view control information to the view component for presentation as the view.

10. The system of claim 1, further comprising a cost component for computing a cost associated with presenting a given view.

11. The system of claim 1, wherein the view is presented based on a majority of data types searched from a datasource.

12. A computer-implemented method of presenting search results, comprising:
receiving a query for execution against a source to return query results;
analyzing the query for query information;
analyzing the source for source information; and
processing the query information and the source information to infer a view for presentation of the results.

13. The method of claim 12, further comprising analyzing view information of other users and selecting the view based on views selected by other users.

14. The method of claim 12, further comprising executing the query and analyzing the results to infer the view in which the results will be presented.

15. The method of claim 12, further comprising automatically inferring and presenting a thumbnail view in response to query information that includes a term related to an image.

16. The method of claim 12, further comprising automatically inferring and presenting an extended details view in response to source information that is associated with a web page.

17. The method of claim 12, further comprising automatically inferring and presenting a details view in response to query information or source information that indicates the results are documents.

18. The method of claim 12, further comprising analyzing additional information that includes device information, user history, search history, view history, query application, and user preferences to infer the view.

19. The method of claim 12, further comprising grouping or stacking the results in the view based on a type of items in the results.

20. A computer-implemented system, comprising:
computer-implemented means for receiving a query for execution against a source to return query results;
computer-implemented means for analyzing the query for query information;
computer-implemented means for analyzing the source for source information; and
computer-implemented means for processing the query information and the source information to infer a view for presentation of the results.
